(19) United States
(12) Patent Application Publication
(10) Pub. No.: US 2022/0250977 A1
(43) Pub. Date: Aug. 11, 2022

(54) METHODS AND APPARATUS FOR MANUFACTURING A GLASS RIBBON

(71) Applicant: Corning Incorporated, Corning, NY (US)

(72) Inventors: Shin-I Huang, Taichung City (TW); Ching Yao Wang, Taichung City (TW); Tinghau Wu, Corning, NY (US); Naiyue Zhou, Painted Post, NY (US)

(21) Appl. No.: 17/636,974

(22) PCT Filed: Sep. 14, 2020
(86) PCT No.: PCT/US2020/050605

§ 371 Date: Feb. 21, 2022

Related U.S. Application Data
(60) Provisional application No. 62/902,587, filed on Sep. 19, 2019.

(51) Int. Cl. C03C 23/00; B08B 11/04; B08B 5/02; B08B 5/04; B08B 7/02; B08B 7/04

(52) U.S. Cl. CPC C03C 23/0075; B08B 11/04; B08B 5/026; C03C 2203/50; B08B 7/02; B08B 7/04; B08B 2205/00; B08B 5/046

(57) ABSTRACT

A glass manufacturing apparatus includes a first nozzle including a first orifice facing a travel path. The glass manufacturing apparatus includes a gas source in fluid communication with the first nozzle, with the gas source directing a gas flow to the first nozzle. The glass manufacturing apparatus includes a controller coupled to one or more of the gas source or the first nozzle to vary the gas flow from the gas source the first nozzle such that the first nozzle is discharges a series of gas bursts through the first orifice toward the travel path at a frequency within a range from about 10 Hz to about 45 Hz. A second nozzle is spaced apart from the first nozzle. The second nozzle includes a second orifice facing the travel path. The second nozzle discharges a continuous gas flow through the second orifice toward the travel path.

This application claims the benefit of priority under 35 U.S.C. § 119 of U.S. Provisional Application Ser. No. 62/902,587, filed on Sep. 19, 2019, the contents of which is relied upon and incorporated herein by reference in its entirety.

### FIELD

The present disclosure relates generally to methods for manufacturing a glass ribbon and, more particularly, to methods for manufacturing a glass ribbon with a glass manufacturing apparatus comprising one or more nozzles.

### BACKGROUND

It is known to manufacture molten material into a glass ribbon with a glass manufacturing apparatus. Following the formation of the glass ribbon, the glass ribbon may be washed and dried prior to packaging. However, during the washing and drying, unwanted particles may adhere to a major surface of the glass ribbon. Removal of the particles may be time-consuming and can cause scratches on the major surface.

### SUMMARY

The following presents a simplified summary of the disclosure to provide a basic understanding of some embodiments described in the detailed description.

In some embodiments, the glass manufacturing apparatus comprises one or more devices that facilitate particle removal while reducing scratching of a major surface. For example, the glass manufacturing apparatus can comprise a vibration inducing device, a particle removal device, an air cleaning device, and a suction device. The vibration inducing device can induce vibration of a glass ribbon, which can dislodge one or more particles from the major surface. The particle removal device can direct a continuous stream of air toward the major surface to further separate the dislodged particles from the major surface. The air cleaning device can discharge a stream of air across a travel direction of the glass ribbon, which can direct airborne particles away from the ribbon. The suction device can generate a negative pressure and receive the airborne particles. Consequently, particles can be removed from a major surface without contacting the major surface and without causing the particles to move along the major surface, thus reducing the likelihood of scratching.

In accordance with some embodiments, a glass manufacturing apparatus comprises a first nozzle comprising a first orifice facing a travel path of the glass manufacturing apparatus. The glass manufacturing apparatus comprises a gas source in fluid communication with the first nozzle and configured to direct a gas flow to the first nozzle. The glass manufacturing apparatus comprises a controller coupled to one or more of the gas source or the first nozzle and configured to vary the gas flow from the gas source through the first nozzle such that the first nozzle is configured to discharge a series of gas bursts through the first orifice toward the travel path at a frequency within a range from about 10 Hz to about 45 Hz. The glass manufacturing apparatus comprises a second nozzle spaced apart from the first nozzle. The second nozzle comprises a second orifice facing the travel path. The second nozzle is configured to discharge a continuous gas flow through the second orifice toward the travel path.

In some embodiments, the first nozzle is configured to discharge the series of gas bursts along a first gas path that is substantially perpendicular to the travel path.

In some embodiments, the second nozzle is rotatable and configured to discharge the continuous gas flow along a plurality of gas paths.

In some embodiments, the glass manufacturing apparatus comprises a third nozzle comprising a third orifice. The third nozzle is configured to discharge a third gas flow through the third orifice along a direction that is substantially parallel to the travel path.

In some embodiments, the third nozzle is positioned on a first side of the travel path.

In some embodiments, the glass manufacturing apparatus comprises a suction device positioned on the first side of the travel path opposite the third nozzle. The suction device is configured to receive the third gas flow.

In accordance with some embodiments, a glass manufacturing apparatus comprises a housing defining a travel path extending in a travel direction. The housing is configured to receive a glass ribbon along the travel path in the travel direction. The glass manufacturing apparatus comprises a first nozzle attached to the housing and configured to discharge a first gas flow toward the travel path to induce vibration in the glass ribbon-forming material and dislodge one or more particles of a group of particles from the glass ribbon. The glass manufacturing apparatus comprises a second nozzle attached to the housing and positioned downstream from the first nozzle relative to the travel direction. The second nozzle is configured to discharge a second gas flow toward the travel path to remove at least a portion of the group of particles from the glass ribbon. The glass manufacturing apparatus comprises a suction device positioned within the housing to receive the at least a portion of the group of particles from the glass ribbon.

In some embodiments, the first nozzle is configured to discharge the first gas flow along a first gas path that is substantially perpendicular to the travel path.

In some embodiments, the second nozzle is rotatable and configured to discharge the second gas flow along a plurality of gas paths.

In some embodiments, the glass manufacturing apparatus comprises a third nozzle comprising a third orifice. The third nozzle is configured to discharge a third gas flow through the third orifice along a direction that is substantially parallel to the travel path.

In some embodiments, the third nozzle is positioned opposite the suction device. The suction device is configured to receive the third gas flow.

In accordance with some embodiments, methods of manufacturing a glass ribbon comprise moving glass ribbon-forming material along a travel path in a travel direction. Methods comprise directing a first gas flow toward the glass ribbon at a resonant frequency of the glass ribbon within a range from about 10 Hz to about 45 Hz to vibrate the glass ribbon and dislodge one or more particles of a group of particles from the glass ribbon Methods comprise directing a second gas flow toward the glass ribbon to remove at least a portion of the group of particles from the glass ribbon.

In some embodiments, methods comprise directing a third gas flow along the glass ribbon in a direction that is substantially parallel to the travel path.

In some embodiments, methods comprise receiving the at least a portion of the group of particles within a suction device positioned within a path of the third gas flow.

In some embodiments, the directing the second gas flow comprises changing an angle of the second gas flow relative to the travel path.

In some embodiments, the moving the glass ribbon comprises receiving the glass ribbon within an opening defined by a housing.

In accordance with some embodiments, methods of manufacturing a glass ribbon comprise moving a glass ribbon along a travel path in a travel direction. Methods comprise directing a first gas flow toward the glass ribbon to vibrate the glass ribbon and dislodge one or more particles of a group of particles from the glass ribbon Methods comprise directing a second gas flow toward the glass ribbon to remove at least a portion of the group of particles from the glass ribbon. Methods comprise receiving the at least a portion of the group of particles within a suction device.

In some embodiments, methods comprise directing a third gas flow along the glass ribbon in a direction that is substantially parallel to the travel path.

In some embodiments, the moving glass ribbon comprises receiving the glass ribbon within an opening defined by a housing.

In some embodiments, the directing the second gas flow comprises changing an angle of the second gas flow relative to the travel path.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings. It is to be understood that both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

These and other features, embodiments and advantages are better understood when the following detailed description is read with reference to the accompanying drawings, in which:

FIG. 1 schematically illustrates a perspective view of example embodiments of a glass manufacturing apparatus in accordance with embodiments of the disclosure;

FIG. 2 illustrates an end view of a housing of the glass manufacturing apparatus along line 2-2 of FIG. 1 in accordance with embodiments of the disclosure;

FIG. 3 illustrates a side view of a vibration inducing device, a particle removal device, an air cleaning device, and a suction device of the glass manufacturing apparatus along line 3-3 of FIG. 2 in accordance with embodiments of the disclosure;

FIG. 4 illustrates a sectional view of a vibration inducing device along line 4-4 of FIG. 3 in accordance with embodiments of the disclosure;

FIG. 5 illustrates a sectional view of a particle removal device along line 5-5 of FIG. 3 in accordance with embodiments of the disclosure; and

FIG. 6 illustrates an end view of an air cleaning device and a suction device along line 6-6 of FIG. 3 in accordance with embodiments of the disclosure.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

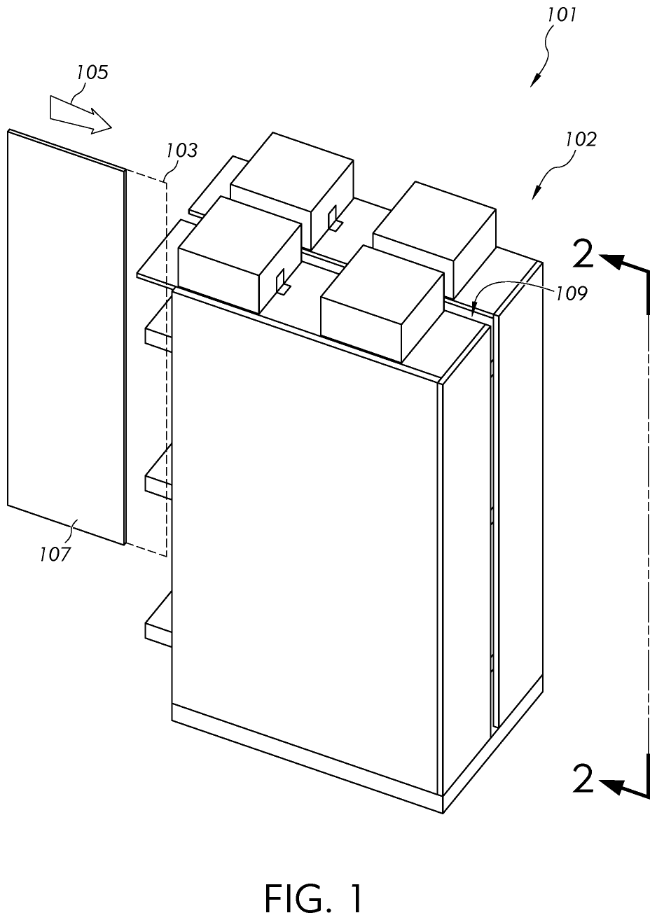

The present disclosure relates to a glass manufacturing apparatus and methods for producing a glass ribbon. For purposes of this application, “glass ribbon” is considered one or more of a glass ribbon in a viscous state, a glass ribbon in an elastic state (e.g., at room temperature) and/or a glass ribbon in a viscoelastic state between the viscous state and the elastic state. Methods and apparatus for producing a glass ribbon 107 will now be described by way of example embodiments for producing the glass ribbon. Referring to FIG. 1, in some embodiments, a glass manufacturing apparatus 101 can comprise a housing 102 defining a travel path 103 extending in a travel direction 105. A glass ribbon 107 can be conveyed along the travel path 103 in the travel direction 105. The housing 102 can receive glass ribbon 107 along the travel path 103 in the travel direction 105. The housing 102 can define an opening 109 within which the glass ribbon 107 can be received. In some embodiments, the housing 102 can be located downstream from a cleaning station, wherein the glass ribbon 107 can be cleaned, for example, with a liquid such as water. Following the cleaning of the glass ribbon 107, one or more particles may accumulate on one or more surfaces of the glass ribbon 107. The housing 102 can receive the glass ribbon 107 and remove at least some of the particles from the one or more surfaces of the glass ribbon 107. In some embodiments, the housing 102 can be located downstream from a cleaning apparatus for cleaning the glass ribbon 107. For example, the cleaning apparatus can wash and dry the glass ribbon 107 prior to conveyance of the glass ribbon 107 to the housing 102.

In some embodiments, methods of manufacturing a glass ribbon can comprise moving the glass ribbon 107 along the travel path 103 in the travel direction 105. For example, the glass ribbon 107 can be moved along the travel path 103 in the travel direction 105 toward the housing 102. The travel path 103 can intersect the opening 109 of the housing 102 such that as the glass ribbon 107 moves in the travel direction 105, the glass ribbon 107 can be received within the opening 109 of the housing 102. In some embodiments, moving the glass ribbon 107 can comprise receiving the glass ribbon 107 within the opening 109 defined by the housing 102.

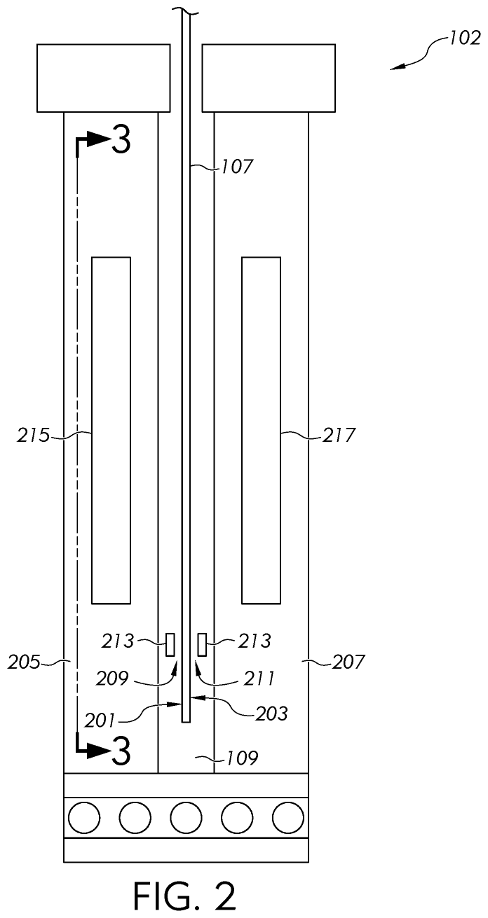

Referring to FIG. 2, an end view of the housing 102 is illustrated along line 2-2 of FIG. 1. In some embodiments, the glass ribbon 107 can comprise a first major surface 201 and a second major surface 203 facing opposite directions and defining a thickness of the glass ribbon 107. In some embodiments, the thickness of the glass ribbon 107 can be less than or equal to about 2 millimeters (mm), less than or equal to about 1 millimeter, less than or equal to about 0.5 millimeters, for example, less than or equal to about 300 micrometers (μm), less than or equal to about 200 micrometers, or less than or equal to about 100 micrometers, although other thicknesses may be provided in further embodiments. For example, in some embodiments, the thickness of the glass ribbon 107 can be within a range from about 20 micrometers to about 200 micrometers, within a range from about 50 micrometers to about 750 micrometers, within a range from about 100 micrometers to about 700 micrometers, within a range from about 200 micrometers to about 600 micrometers, within a range from about 300 micrometers to about 500 micrometers, within a range from about 50 micrometers to about 500 micrometers, within a range from about 50 micrometers to about 700 micrometers, within a range from about 50 micrometers to about 600 micrometers, within a range from about 50 micrometers to about 500 micrometers, within a range from about 50 micrometers to about 400 micrometers, within a range from about 50 micrometers to about 300 micrometers, within a range from about 50 micrometers to about 200 micrometers, within a range from about 50 micrometers to about 100 micrometers, within a range from about 25 micrometers to about 125 micrometers, comprising all ranges and subranges of thicknesses therebetween. In addition, the glass ribbon 107 can comprise a variety of compositions, for example, borosilicate glass, alumino-borosilicate glass, alkali-containing glass, or alkali-free glass, alkali aluminosilicate glass, alkaline earth aluminosilicate glass, soda-lime glass, glass ceramic, etc. In some embodiments, the glass ribbon 107 can be processed into a desired application, e.g., a display application. For example, the glass ribbon 107 can be used in a wide range of display applications, comprising liquid crystal displays (LCDs), electrophoretic displays (EPD), organic light emitting diode displays (OLEDs), plasma display panels (PDPs), touch sensors, photovoltaics, and other electronic displays.

In some embodiments, the housing 102 can comprise one or more wall enclosures, for example, a first wall enclosure 205 and a second wall enclosure 207. The first wall enclosure 205 can be positioned on a first side 209 of the glass ribbon 107 facing the first major surface 201. The second wall enclosure 207 can be positioned on a second side 211 of the glass ribbon 107 facing the second major surface 203. In some embodiments, the first wall enclosure 205 and the second wall enclosure 207 can be spaced apart to define the opening 109 within which the glass ribbon 107 extends along the travel path 103. For example, a distance separating the first wall enclosure 205 and the second wall enclosure 207 can be greater than a thickness of the glass ribbon 107, such that the glass ribbon 107 can be conveyed through the housing 102 without the glass ribbon 107 contacting the first wall enclosure 205 or the second wall enclosure 207.

The glass ribbon 107 can be supported in several ways relative to the housing 102. In some embodiments, a top portion of the glass ribbon 107 can be clamped with one or more mechanical clamps, such that the glass ribbon 107 can be moved by an overhead conveyor. By clamping a top portion of the glass ribbon 107, the glass ribbon 107 can be supported at a location above the housing 102, which can improve conveyance of the glass ribbon 107 through the opening 109, for example, due to a relatively limited distance between the glass ribbon 107, the first wall enclosure 205, and the second wall enclosure 207. In addition, or in the alternative, the housing 102 can comprise one or more structures that can limit inadvertent contact between the glass ribbon 107 and portions of the housing 102, for example, the first wall enclosure 205, the second wall enclosure 207, etc. For example, the housing 102 can comprise one or more edge guides 213 that can guide the glass ribbon 107 through the opening 109. The edge guides 213 can be positioned within the opening 109 and may be in closer proximity to the glass ribbon 107 than the first wall enclosure 205 and/or the second wall enclosure 207. For example, a distance separating one of the edge guides 213 from the glass ribbon 107 may be less than a distance separating either of the first wall enclosure 205 or the second wall enclosure 207 from the glass ribbon 107. The edge guides 213 can be spaced apart such that the glass ribbon 107 can pass between the edge guides 213. In the event of lateral movement of the glass ribbon 107 (e.g., toward the first wall enclosure 205 or the second wall enclosure 207), the glass ribbon 107 can contact the edge guides 213 and not the first wall enclosure 205 or the second wall enclosure 207. The edge guides 213 can comprise a dampening material, for example, a padded material, that can limit damage to the glass ribbon 107 when the glass ribbon 107 contacts the edge guides 213.

In some embodiments, the first wall enclosure 205 and the second wall enclosure 207 can comprise a cleaning apparatus for cleaning the glass ribbon 107. For example, the first wall enclosure 205 can comprise a first cleaning apparatus 215 and the second wall enclosure 207 can comprise a second cleaning apparatus 217. In some embodiment, the first cleaning apparatus 215 can clean the first major surface 201 of the glass ribbon 107, while the second cleaning apparatus 217 can clean the second major surface 203 of the glass ribbon 107. In some embodiments, as the glass ribbon 107 moves through the opening 109 within the housing 102, the first cleaning apparatus 215 and the second cleaning apparatus 217 can direct air toward the first major surface 201 and the second major surface 203, respectively. The air can remove particles that may have accumulated on the first major surface 201 and the second major surface 203, thus cleaning the glass ribbon 107.

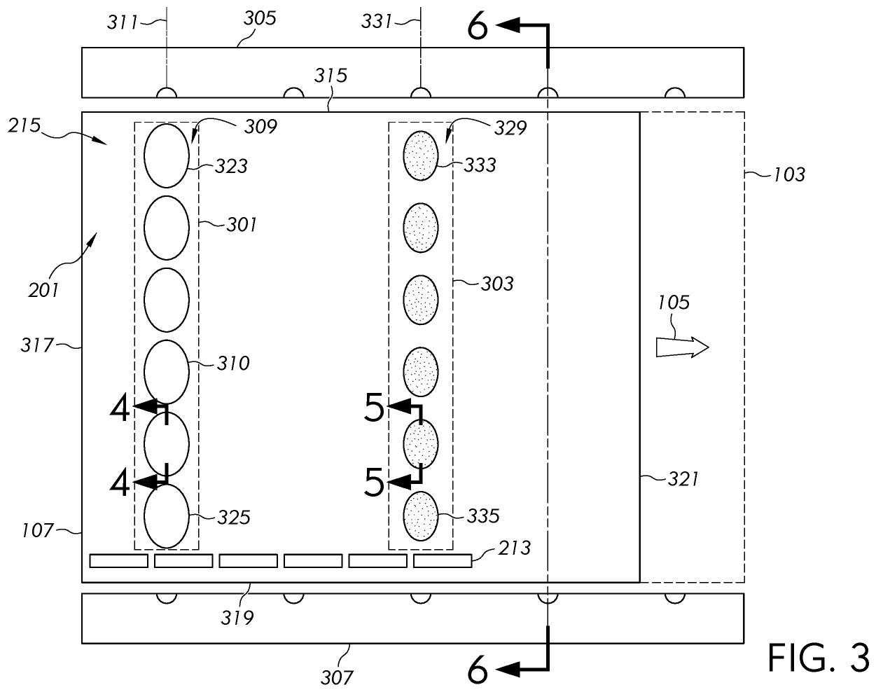

Referring to FIG. 3, a side view of the first cleaning apparatus 215 of the first wall enclosure 205 along line 3-3 of FIG. 2 is illustrated. In some embodiments, the first cleaning apparatus 215 may be substantially identical to the second cleaning apparatus 217, with the first cleaning apparatus 215 facing the first major surface 201 and the second cleaning apparatus 217 facing the second major surface 203. In some embodiments, the first cleaning apparatus 215 can comprise a vibration inducing device 301, a particle removal device 303, an air cleaning device 305, and a suction device 307. The vibration inducing device 301 can be located upstream from the particle removal device 303 relative to the travel direction 105. For example, when the glass ribbon 107 travels along the travel path 103 in the travel direction 105, the glass ribbon 107 can pass the vibration inducing device 301 prior to passing the particle removal device 303. In some embodiments, the vibration inducing device 301 can comprise a plurality of nozzles, for example, a plurality of first nozzles 309. The plurality of first nozzles 309 may comprise first nozzles that may be spaced apart from adjacent first nozzles and may be oriented along a first nozzle axis 311. In some embodiments, the first nozzle axis 311 may be substantially perpendicular to the travel direction 105.

In some embodiments, the glass ribbon 107 can comprise a first edge 315, a second edge 317, a third edge 319, and a fourth edge 321. The first edge 315 and the third edge 319 can be located opposite one another, for example, with the first edge 315 comprising a top edge of the glass ribbon 107, and the third edge 319 comprising a bottom edge of the glass ribbon 107. In some embodiments, the first edge 315 can extend substantially parallel to the third edge 319. The second edge 317 can extend between the first edge 315 and the third edge 319, and the fourth edge 321 can extend between the first edge 315 and the third edge 319. In some embodiments, the second edge 317 and the fourth edge 321 can be spaced apart from one another, with the second edge 317 extend substantially parallel to the fourth edge 321. In some embodiments, the fourth edge 321 can comprise a leading edge of the glass ribbon 107 when the glass ribbon 107 travels along the travel path 103 in the travel direction 105. In some embodiments, the second edge 317 can comprise a trailing edge of the glass ribbon when the glass ribbon 107 travels along the travel path 103 in the travel direction 105. For example, the fourth edge 321 may pass the vibration inducing device 301 prior to the second edge 317 passing the vibration inducing device 301 when the glass ribbon 107 travels along the travel path 103 in the travel direction 105.

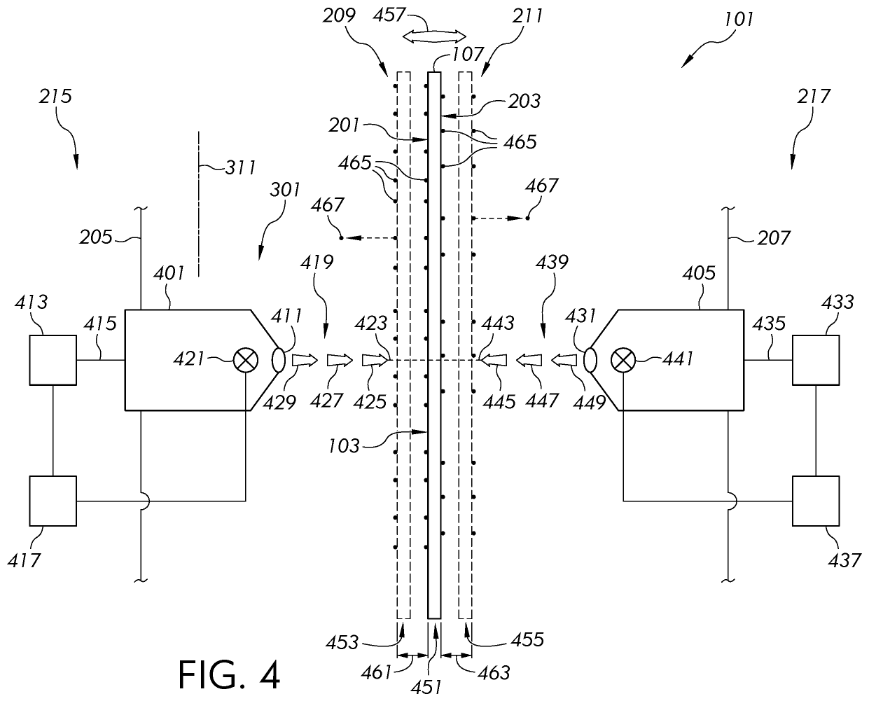

In some embodiments, the vibration inducing device 301 can extend between the first edge 315 and the third edge 319, with the first nozzle axis 311 substantially parallel to the second edge 317 and the fourth edge 321. For example, the plurality of first nozzles 309 may be spaced apart along a height of the glass ribbon 107, wherein an uppermost first nozzle 323 may be in closer proximity to the first edge 315 than to the third edge 319, and a lowermost first nozzle 325 may be in closer proximity to the third edge 319 than to the first edge 315. The uppermost first nozzle 323 may comprise an uppermost nozzle that is bordered by one nozzle along the first nozzle axis 311, while the lowermost first nozzle 325 may comprise a lowermost nozzle that is bordered by one nozzle along the first nozzle axis 311. In some embodiments, the plurality of first nozzles 309 may be located on a side of (e.g., on an upper side of) the edge guides 213. The first nozzles of the plurality of first nozzles 309 may be spaced a substantially constant distance apart from adjacent first nozzles. In some embodiments, the plurality of first nozzles 309 can lie between the first edge 315 and the third edge 319, with none of the plurality of first nozzles 309 lying outside of the first edge 315 or the third edge 319. For example, a first axis that is perpendicular to the first major surface 201 can intersect the uppermost first nozzle 323 and the glass ribbon 107, while a second axis that is perpendicular to the first major surface 201 can intersect the lowermost first nozzle 325 and the glass ribbon 107. Additional axes that are perpendicular to the first major surface 201 can intersect the other first nozzles that are located between the uppermost first nozzle 323 and the lowermost first nozzle 325. As will be described relative to FIG. 4, the vibration inducing device 301 can induce a vibration in the glass ribbon 107, which can dislodge particles on the first major surface 201 and/or the second major surface 203 of the glass ribbon 107.

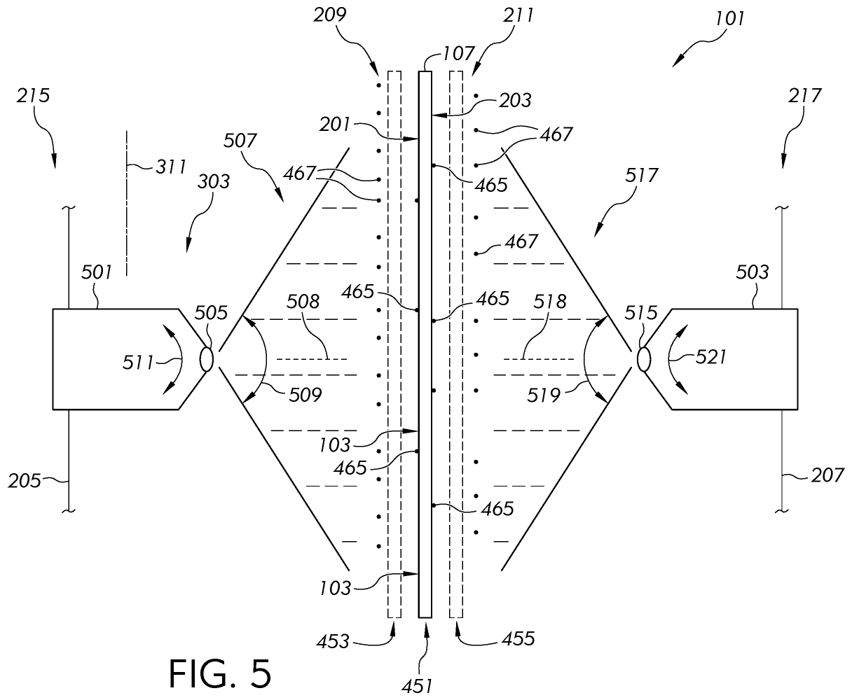

In some embodiments, the particle removal device 303 can comprise a plurality of nozzles, for example, a plurality of second nozzles 329. The plurality of second nozzles 329 may comprise second nozzles that may be spaced apart from adjacent second nozzles and may be oriented along a second nozzle axis 331. The plurality of second nozzles 329 can be spaced apart from the plurality of first nozzles 309 relative to the travel direction 105. In some embodiments, the second nozzle axis 331 may be substantially perpendicular to the travel direction 105 and substantially parallel to the first nozzle axis 311. For example, the particle removal device 303 can extend between the first edge 315 and the third edge 319, with the second nozzle axis 331 substantially parallel to the second edge 317 and the fourth edge 321. For example, the plurality of second nozzles 329 may be spaced apart along a height of the glass ribbon 107, wherein an uppermost second nozzle 333 may be in closer proximity to the first edge 315 than to the third edge 319, and a lowermost second nozzle 335 may be in closer proximity to the third edge 319 than to the first edge 315. In some embodiments, the plurality of second nozzles 329 may be located on a side of (e.g., on an upper side of) the edge guides 213. The second nozzles of the plurality of second nozzles 329 may be spaced a substantially constant distance apart from adjacent second nozzles. In some embodiments, the plurality of second nozzles 329 can lie between the first edge 315 and the third edge 319, with none of the plurality of second nozzles 329 lying outside of the first edge 315 or the third edge 319. For example, a first axis that is perpendicular to the first major surface 201 can intersect the uppermost second nozzle 333 and the glass ribbon 107, while a second axis that is perpendicular to the first major surface 201 can intersect the lowermost second nozzle 335 and the glass ribbon 107. Additional axes that are perpendicular to the first major surface 201 can intersect the other second nozzles that are located between the uppermost second nozzle 333 and the lowermost second nozzle 335. As will be described relative to FIG. 5, the particle removal device 303 can direct a gas flow toward the glass ribbon 107, which can remove particles from the first major surface 201 and/or the second major surface 203 of the glass ribbon 107.

Referring to FIG. 4, a sectional view of a first nozzle 401 of the plurality of first nozzles 309 of the vibration inducing device 301 along line 4-4 of FIG. 3 is illustrated. The first nozzle 401 may be substantially identical in structure and function to the other nozzles of the plurality of first nozzles 309, with the other nozzles arranged above and below the first nozzle 401 along the first nozzle axis 311. The first nozzle 401 may be positioned on the first side 209 of the glass ribbon 107, while a first nozzle 405 of the second cleaning apparatus 217 can be positioned on a second side 211 of the glass ribbon 107. Though positioned on opposing sides 209, 211 of the glass ribbon 107, the first nozzles 401, 405 may be substantially identical in structure and function. In some embodiments, the first nozzle 401 can be attached to the first wall enclosure 205 of the housing 102 (e.g., housing 102 illustrated in FIGS. 1-2) while the first nozzle 405 can be attached to the second wall enclosure 207 of the housing 102. With reference to the first nozzle 401, the first nozzle 401 can comprise a first orifice 411 facing the travel path 103 (e.g., wherein the glass ribbon 107 lies within the travel path 103 in FIG. 4) of the glass manufacturing apparatus 101. For example, in some embodiments, by facing the travel path 103, an axis perpendicular to the travel path 103 can extend from the travel path 103 toward the first nozzle 401 and may intersect the first orifice 411 prior to intersecting another portion of the first nozzle 401. In some embodiments, the first orifice 411 can face the travel path 103 while not being perpendicular to the travel path 103. For example, an axis may extend non-perpendicular relative to the travel path 103 and can extend from the travel path 103 toward the first nozzle 401 and may intersect the first orifice 411 prior to intersecting another portion of the first nozzle 401.

In some embodiments, the vibration inducing device 301 can comprise a gas source 413 in fluid communication with the first nozzle 401, with the gas source 413 configured to direct a gas flow to the first nozzle 401. For example, the gas source 413 can deliver a compressed gas (e.g., air) to the first nozzle 401. The gas source 413 can be in fluid communication with the first nozzle 401 in several ways. For example, in some embodiments, a substantially hollow conduit 415 (e.g., a tube, a pipe, a hose, etc.) can couple the gas source 413 and the first nozzle 401, such that the gas flow can be delivered from the gas source 413, through the conduit 415, and to the first nozzle 401. In some embodiments, the first nozzle 401 can be substantially hollow and may receive the gas flow from the gas source 413 within the first nozzle 401, for example, within a chamber of the first nozzle 401.

In some embodiments, the vibration inducing device 301 can comprise a controller 417. The controller 417 may be coupled to one or more of the gas source 413 or the first nozzle 401 and can vary the gas flow from the gas source 413 through the first nozzle 401, such that the first nozzle 401 can discharge a first gas flow 419 (e.g., in the form of a series of gas bursts) through the first orifice 411 toward the travel path 103 at a frequency within a range from about 10 Hertz (Hz) to about 45 Hz. For example, in some embodiments, by being discharged toward the travel path 103, the first gas flow 419 can be discharged substantially perpendicular to or at a tilted angle (e.g., greater than or less than 90 degrees) relative to the first major surface 201 of the glass ribbon 107 that is conveyed along the travel path 103. In some embodiments, the gas flow may comprise a compressed gas, such that the gas flow may be discharged from the first nozzle 401 and through the first orifice 411. In some embodiments, the controller 417 can cause the gas flow to be non-continuously discharged through the first orifice 411. For example, in some embodiments, the controller 417 can be coupled to the gas source 413 and can trigger a non-continuous delivery of the gas flow from the gas source 413 to the first nozzle 401. The non-continuous delivery to the first nozzle 401 can cause the first nozzle 401 to discharge the first gas flow 419 as a series of gas bursts through the first orifice 411. In addition, or in the alternative, in some embodiments, the controller 417 can be coupled to the first nozzle 401, for example, a valve 421 within the first nozzle 401. The valve 421 can be positioned within a fluid flow path of the first nozzle 401 to the first orifice 411. The valve 421 can be switched between an opened position, in which the gas flow can be discharged through the first orifice 411, and a closed position, in which the gas flow can be stopped from being discharged through the first orifice 411. The controller 417 can control the switching between the opened position and the closed position of the valve 421. For example, when the controller 417 switches the valve 421 to the opened position, a gas burst may be discharged from the first orifice 411. When the controller 417 switches the valve 421 to the closed position, gas is stopped from being discharged through the first orifice 411.

In some embodiments, the first nozzle 401 can discharge the first gas flow 419 along a first gas path 423 that may be substantially perpendicular to the travel path 103. For example, the first gas path 423 can intersect the travel path 103 along which the glass ribbon 107 travels. In some embodiments, the first gas path 423 may be non-perpendicular to the travel path 103, for example, by forming an angle that is greater than or less than 90 degrees relative to the travel path 103. In some embodiments, the first gas flow 419 can comprise a plurality of non-continuous gas bursts, for example, a first gas burst 425, a second gas burst 427, a third gas burst 429, etc. The first gas burst 425, the second gas burst 427, and the third gas burst 429 may be represented by separate arrows, wherein gaps between the arrows can represent a period of time when gas is not being discharged through the first orifice 411. For example, the controller 417 can cause the gas source 413 to deliver the gas flow to the first nozzle 401, wherein the gas flow can be discharged through the first orifice 411 as the first gas burst 425. Following the discharge of the first gas burst 425 for a period of time, the controller 417 can stop the discharge of gas through the first orifice 411, for example, by stopping the delivery of gas from the gas source 413 and/or by switching the valve 421 to the closed position. During this period, the non-discharge of gas from the first orifice 411 may be represented by a gap or a space between the first gas burst 425 and the second gas burst 427. Following this temporary cessation of gas discharge through the first orifice 411, the controller 417 can again allow the discharge of gas through the first orifice 411, for example, by allowing the delivery of gas from the gas source 413 and/or by switching the valve 421 to the opened position. The gas discharged through the first orifice 411 can comprise the second gas burst 427. Following the discharge of the second gas burst 427 for a period of time, the controller 417 can stop the discharge of gas through the first orifice 411, for example, by stopping the delivery of gas from the gas source 413 and/or by switching the valve 421 to the closed position. During this period, the non-discharge of gas from the first orifice 411 may be represented by a gap or a space between the second gas burst 427 and the third gas burst 429. Following this temporary cessation of gas discharge through the first orifice 411, the controller 417 can again allow the discharge of gas through the first orifice 411, for example, by allowing the delivery of gas from the gas source 413 and/or by switching the valve 421 to the opened position. The gas discharged through the first orifice 411 can comprise the third gas burst 429.

In some embodiments, the first nozzle 405 of the second cleaning apparatus 217 can be substantially identical to the first nozzle 401 of the first cleaning apparatus 215. For example, the first nozzle 405 can comprise a first orifice 431 facing the travel path 103 (e.g., wherein the glass ribbon 107 lies within the travel path 103 in FIG. 4) of the glass manufacturing apparatus 101. In some embodiments, by facing the travel path 103, an axis perpendicular to the travel path 103 can extend from the travel path 103 toward the first nozzle 405 and may intersect the first orifice 431 prior to intersecting another portion of the first nozzle 405. In some embodiments, the first orifice 431 can face the travel path 103 while not being perpendicular to the travel path 103. For example, an axis may extend non-perpendicular relative to the travel path 103 and can extend from the travel path 103 toward the first nozzle 405 and may intersect the first orifice 431 prior to intersecting another portion of the first nozzle 405. In some embodiments, a gas source 433 can be in fluid communication with the first nozzle 405, with the gas source 433 configured to direct a gas flow to the first nozzle 405. The gas source 433 can be substantially identical to the gas source 413. For example, the gas source 433 can deliver a compressed gas (e.g., air) to the first nozzle 405. The gas source 433 may be in fluid communication with the first nozzle 405 in several ways. For example, in some embodiments, a substantially hollow conduit 435 (e.g., a tube, a pipe, a hose, etc.) can couple the gas source 433 and the first nozzle 405, such that the gas flow can be delivered from the gas source 433, through the conduit, and to the first nozzle 405. In some embodiments, the first nozzle 405 can be substantially hollow and may receive the gas flow from the gas source 433 within the first nozzle 405, for example, within a chamber of the first nozzle 405.

In some embodiments, a controller 437 may be coupled to one or more of the gas source 433 or the first nozzle 405 and can vary the gas flow from the gas source 433 through the first nozzle 405, such that the first nozzle 405 can discharge a first gas flow 439 (e.g., in the form of a series of gas bursts) through the first orifice 431 toward the travel path 103 at a frequency within a range from about 10 Hertz (Hz) to about 45 Hz. For example, in some embodiments, by being discharged toward the travel path 103, the first gas flow 439 can be discharged substantially perpendicular to or at a tilted angle (e.g., greater than or less than 90 degrees) relative to the second major surface 203 of the glass ribbon 107 that is conveyed along the travel path 103. The controller 437 coupled to the gas source 433 or the first nozzle 405 may be substantially identical to the controller 417 of the first cleaning apparatus 215. For example, the gas flow may comprise a compressed gas, such that the gas flow may be discharged from the first nozzle 405 and through the first orifice 431. In some embodiments, the controller 437 can be coupled to the gas source 433 and can trigger a non-continuous delivery of the gas flow from the gas source 433 to the first nozzle 405. The non-continuous delivery to the first nozzle 405 can cause the first nozzle 405 to discharge the first gas flow 439 as a series of gas bursts through the first orifice 431. In addition, or in the alternative, in some embodiments, the controller 437 can be coupled to the first nozzle 405, for example, a valve 441 within the first nozzle 405. The valve 441 can be substantially identical to the valve 421 within the first nozzle 401. For example, the valve 441 can be positioned within a fluid flow path of the first nozzle 405 to the first orifice 431. The valve 441 can be switched between an opened position, in which the gas flow can be discharged through the first orifice 431, and a closed position, in which the gas flow can be stopped from being discharged through the first orifice 431. The controller 417 can control the switching between the opened position and the closed position of the valve 441, wherein when the controller 437 switches the valve 441 to the opened position, a gas burst may be discharged from the first orifice 411, and when the controller 437 switches the valve 441 to the closed position, gas is stopped from being discharged through the first orifice 431. In some embodiments, the first nozzle 405 can discharge the first gas flow 439 along a first gas path 423 that may be substantially perpendicular to the travel path 103. In some embodiments, the first gas path 443 may be collinear with the first gas path 423, though, in other embodiments, the first gas path 443 may be offset from the first gas path 423. The first gas path 443 can intersect the travel path 103 along which the glass ribbon 107 travels. In some embodiments, the first gas path 443 may be non-perpendicular to the travel path 103, for example, by forming an angle that is greater than or less than 90 degrees relative to the travel path 103. In some embodiments, the first gas flow 439 can comprise a plurality of non-continuous gas bursts, for example, a first gas burst 445, a second gas burst 447, a third gas burst 449, etc. The first gas burst 445, the second gas burst 447, and the third gas burst 449 may be represented by separate arrows, wherein gaps between the arrows can represent a period of time when gas is not being discharged through the first orifice 411.

In some embodiments, the first gas flow 419, 439 can be discharged through the first orifice 411, 431 at a resonant frequency of the glass ribbon 107, for example, at a frequency within a range from about 10 Hertz (Hz) to about 45 Hz. The resonant frequency of the glass ribbon 107 is the frequency at which the glass ribbon 107 will vibrate at a maximum amplitude. For example, at the resonant frequency of the glass ribbon 107, the glass ribbon 107 can vibrate at a larger amplitude than at other, non-resonant frequencies. Periodic driving forces, for example, in the form of the series of gas bursts (e.g., the first gas flow 419, 439) may be relatively small but can produce relatively large vibrations due to the glass ribbon 107 storing vibrational energy. As the series of gas bursts (e.g., the first gas flow 419, 439) are discharged toward the glass ribbon 107, the glass ribbon 107 can vibrate. When the series of gas bursts (e.g., the first gas flow 419, 439) are discharged at the resonant frequency of the glass ribbon 107, the amplitude of the vibration of the glass ribbon 107 may be at a maximum.

In some embodiments, the resonant frequency of the glass ribbon 107 can be determined. For example, based on the characteristics (e.g., dimensions, shape, material, etc.) of the glass ribbon 107, a resonant frequency of the glass ribbon 107 may be within a range from about 10 Hz to about 45 Hz. For 1 Hz, the first nozzle 401, 405 can discharge one gas burst per second. For example, at 10 Hz, the first nozzle 401 can discharge the first gas flow 419 as a series of gas bursts at a rate of 10 bursts per second. Similarly, at 10 Hz, the first nozzle 405 can discharge the first gas flow 439 as a series of gas bursts at a rate of 10 bursts per second. At 45 Hz, the first nozzle 401 can discharge the first gas flow 419 as a series of gas bursts at a rate of 45 bursts per second. Similarly, at 45 Hz, the first nozzle 405 can discharge the first gas flow 439 as a series of gas bursts at a rate of 45 bursts per second. As such, depending on the resonant frequency of the glass ribbon 107, the controller 417, 437 can control the rate at which the first gas flow 419, 439 may be discharged from the first nozzle 401, 405. In some embodiments, the first gas flow 419 discharged from the first nozzle 401 can be synchronized with the first gas flow 439 discharged from the first nozzle 405. For example, the series of gas bursts from the first nozzle 401 can impact the glass ribbon 107 between bursts of the series of gas bursts from the first nozzle 405. The first gas flow 419, 439 is not limited to being discharged at the resonant frequency of the glass ribbon 107. For example, in some embodiments, even when the resonant frequency is not attained by the first gas flow 419, 439, the glass ribbon 107 may still vibrate. When the first gas flow 419, 439 is discharged at a frequency that is other than the resonant frequency of the glass ribbon 107, the glass ribbon 107 may vibrate.

The vibration of the glass ribbon 107 may be represented with dashed lines in FIG. 4. For example, when the first gas flow 419, 439 is not being discharged toward the glass ribbon 107, the glass ribbon 107 may be in a first position 451 (e.g., illustrated with solid lines), in which the glass ribbon 107 extends along the travel path 103. When the first gas flow 419, 439 is discharged and impinges upon the glass ribbon 107, the glass ribbon 107 can vibrate along a vibrational direction 457. In some embodiments, the vibrational direction 457 may be substantially parallel to the first gas path 423, 443, and may be substantially perpendicular to the first major surface 201 and the second major surface 203 of the glass ribbon 107. As the glass ribbon 107 vibrates along the vibrational direction 457, the glass ribbon 107 can move between the first position 451, a second position 453, and a third position 455, wherein the second position 453 and the third position 455 are illustrated with dashed lines. In some embodiments, the glass ribbon 107 can move a first distance 461 when vibrating between the first position 451 and the second position 453 along the vibrational direction 457, wherein the first distance 461 may comprise a maximum vibrational distance when the first gas flow 419, 439 is discharged at the resonant frequency of the glass ribbon 107. In some embodiments, the glass ribbon 107 can move a second distance 463 when vibrating between the first position 451 and the third position 455 along the vibrational direction 457, wherein the second distance 463 may comprise the maximum vibrational distance when the first gas flow 419, 439 is discharged at the resonant frequency of the glass ribbon 107. In some embodiments, when the first gas flow 419, 439 is discharged at frequency other than the resonant frequency of the glass ribbon 107, the first distance 461 and the second distance 463 may be smaller than the maximum vibrational distance.

In some embodiments, the vibration of the glass ribbon 107 caused by the impingement of the first gas flow 419, 439 upon the glass ribbon 107 can dislodge one or more particles 465 from the first major surface 201 and/or the second major surface 203. For example, following a washing and drying procedure of the glass ribbon 107, the one or more particles 465 may accumulate on and adhere to the first major surface 201 and/or the second major surface 203. To remove at least a portion of these particles 465, the glass ribbon 107 can be vibrated, for example, between the first position 451, the second position 453, and the third position 455. In some embodiments, the first nozzle 401, 405 can discharge the first gas flow 419, 439 toward the travel path 103 to induce vibration in the glass ribbon 107 and dislodge the one or more particles 465 of a group of particles from the glass ribbon 107. The vibration can cause a rapid change of direction of the glass ribbon 107, for example, from the second position 453 toward the first position 451, and from the third position 455 toward the first position 451. The vibration, and, thus, the change of direction, of the glass ribbon 107 can cause at least a portion of the particles 465 to become dislodged from the first major surface 201 and/or the second major surface 203. For example, dislodged particles 467 may be separated from the first major surface 201 and/or the second major surface 203. In some embodiments, the dislodged particles 467 may be spaced apart from the first major surface 201 and/or the second major surface 203, with the dislodged particles 467 present in the airspace adjacent to the first major surface 201 and/or the second major surface 203. In some embodiments, the dislodged particles 467 may remain in contact with the first major surface 201 and/or the second major surface 203, though, the dislodged particles 467 may be loosened and an adhesion between the dislodged particles 467 and the first major surface 201 and/or the second major surface 203 may be reduced, thus facilitating removal of the dislodged particles 467.

In some embodiments, methods of manufacturing a glass ribbon can comprise directing the first gas flow 419, 439 toward the glass ribbon 107 at a resonant frequency of the glass ribbon 107 within a range from about 10 Hz to about 45 Hz to vibrate the glass ribbon 107 and dislodge one or more particles (e.g., the dislodged particles 467) of a group of particles 465 from the glass ribbon 107. For example, a resonant frequency of the glass ribbon 107 can be determined and, based on the resonant frequency, the first gas flow 419, 439 can be directed toward the glass ribbon 107 to vibrate the glass ribbon 107. In some embodiments, the vibration of the glass ribbon 107 can dislodge some of the particles 465 from the first major surface 201 and/or the second major surface 203. The first gas flow 419, 439 is not limited to being directed toward the glass ribbon 107 at the resonant frequency of the glass ribbon 107. For example, in some embodiments, methods of manufacturing a glass ribbon can comprise directing the first gas flow 419, 439 toward the glass ribbon 107 to vibrate the glass ribbon 107 and dislodge one or more particles (e.g., the dislodged particles 467) of a group of particles 465 from the glass ribbon 107. For example, even when the glass ribbon 107 is not vibrated at a resonant frequency, the particles 465 may still be dislodged from the first major surface 201 and/or the second major surface 203.

Referring to FIG. 5, a sectional view of a second nozzle 501 of the plurality of second nozzles 329 of the particle removal device 303 along line 5-5 of FIG. 3 is illustrated. The second nozzle 501 may be substantially identical in structure and function to the other nozzles of the plurality of second nozzles 329, with the other second nozzles arranged above and below the second nozzle 501 along the second nozzle axis 331. The second nozzle 501 may be positioned on the first side 209 of the glass ribbon 107 while a second nozzle 503 of the second cleaning apparatus 217 can be positioned on the second side 211 of the glass ribbon 107. The second nozzles 501, 503 may be substantially identical in structure and function. In some embodiments, the second nozzle 501 can be attached to the first wall enclosure 205 of the housing 102 (e.g., housing 102 illustrated in FIGS. 1-2) while the second nozzle 503 can be attached to the second wall enclosure 207 of the housing 102. With reference to the second nozzle 501, the second nozzle 501 can comprise a second orifice 505 facing the travel path 103 (e.g., wherein the glass ribbon 107 lies within the travel path 103 in FIG. 5) of the glass manufacturing apparatus 101. For example, in some embodiments, by facing the travel path 103, an axis perpendicular to the travel path 103 can extend from the travel path 103 toward the second nozzle 501 and may intersect the second orifice 505 prior to intersecting another portion of the second nozzle 501. In some embodiments, the second orifice 505 can face the travel path 103 while not being perpendicular to the travel path 103. For example, an axis may extend non-perpendicular relative to the travel path 103 and can extend from the travel path 103 toward the second orifice 505 and may intersect the second orifice 505 prior to intersecting another portion of the second nozzle 501. In some embodiments, a gas source, for example, the gas source 413 (e.g., illustrated in FIG. 4) or a separate gas source, can be in fluid communication with the second nozzle 501, with the gas source configured to direct a gas flow to the second nozzle 501.

In some embodiments, the second nozzle 501 can discharge a second gas flow 507, for example, a continuous gas flow, through the second orifice 505 toward the travel path 103. In some embodiments, second nozzle 501 can discharge the second gas flow 507 along a second gas path 508 that may be substantially perpendicular to the travel path 103 (e.g., substantially perpendicular to or at a tilted angle (e.g., greater than or less than 90 degrees) relative to the first major surface 201 of the glass ribbon 107 that is conveyed along the travel path 103). For example, the second gas path 508 can intersect the travel path 103 along which the glass ribbon 107 travels. In some embodiments, the second gas path 508 may be non-perpendicular to the travel path 103, for example, by forming an angle that is greater than or less than 90 degrees relative to the travel path 103. In contrast with the first gas flow 419, 439 (e.g., illustrated in FIG. 4) which may comprise a series of gas bursts (e.g., the first gas burst 425, 445, the second gas burst 427, 447, the third gas burst 429, 449, etc.), the second gas flow 507 can comprise a continuous gas flow that may be uninterrupted. For example, the second gas flow 507 may remove the dislodged particles 467 from the first major surface 201 of the glass ribbon 107, while not causing a vibration of the glass ribbon 107. As such, since the second gas flow 507 may not be intended to cause vibration, the second gas flow 507 can comprise the continuous gas flow that may remove the dislodged particles 467 and, in some embodiments, may dislodge some particles 465 that were not dislodged by the first gas flow 419, 439. In some embodiments, the second gas flow 507 can remove the particles 465, 467 by creating air turbulence adjacent to the first major surface 201. This air turbulence can cause the particles 465, 467 to further separate from the first major surface 201, for example, by increasing a distance that separates the particles 465, 467 from the first major surface 201.

In some embodiments, to facilitate the removal of the particles 465, 467 from a larger area of the glass ribbon 107, the second gas flow 507 can comprise a cone shape. For example, the second nozzle 501 can discharge the second gas flow 507 within a spray angle 509 range from about 0 degrees to about 180 degrees, or within a spray angle 509 range from about 0 degrees to about 90 degrees, or within a spray angle 509 range from about 20 degrees to about 90 degrees. The spray angle 509 can be varied in several ways. For example, a cross-sectional size (e.g., diameter) of the second orifice 505 can be altered, which can correspondingly alter the spray angle 509. In some embodiments, the second nozzle 501 may be fixed relative to the first wall enclosure 205, such that a location at which the second gas path 508 intersects the glass ribbon 107 may be fixed. In some embodiments, the second nozzle 501 may be movable relative to the first wall enclosure 205, for example, with the second nozzle 501 being rotatable and configured to discharge the continuous gas flow along a plurality of gas paths. For example, the second nozzle 501 may be rotatable about a rotation direction 511 relative to the first wall enclosure 205. Though the rotation direction 511 is illustrated as an up/down direction in FIG. 5, the rotation direction 511 is not so limited, and in some embodiments, the rotation direction 511 can comprise a 360 degree rotation direction 511 (e.g., up/down, into/out of the page, and at other angles in between). The rotatability of the second nozzle 501 can allow for the continuous gas flow to be discharged along a plurality of gas paths, wherein some of the gas paths may be non-perpendicular relative to the travel path 103.

In some embodiments, the second nozzle 503 of the second cleaning apparatus 217 can be substantially identical to the second nozzle 501 of the first cleaning apparatus 215. For example, the second nozzle 503 can comprise a second orifice 515 facing the travel path 103 of the glass manufacturing apparatus 101. For example, by facing the travel path 103, an axis perpendicular to the travel path 103 can extend from the travel path 103 toward the second nozzle 503 and may intersect the second orifice 515 prior to intersecting another portion of the second nozzle 503. In some embodiments, the second orifice 515 can face the travel path 103 while not being perpendicular to the travel path 103. For example, an axis may extend non-perpendicular relative to the travel path 103 and can extend from the travel path 103 toward the second orifice 515 and may intersect the second orifice 515 prior to intersecting another portion of the second nozzle 503. In some embodiments, a gas source, for example, the gas source 433 or a separate gas source, can be in fluid communication with the second nozzle 503, with the gas source configured to direct a gas flow to the second nozzle 503. In some embodiments, the second nozzle 503 can discharge a second gas flow 517, for example, a continuous gas flow, through the second orifice 515 toward the travel path 103. In some embodiments, second nozzle 503 can discharge the second gas flow 517 along a second gas path 518 that may be substantially perpendicular to the travel path 103. For example, the second gas path 518 can intersect the travel path 103 along which the glass ribbon 107 travels. In some embodiments, the second gas path 518 may be non-perpendicular to the travel path 103, for example, by forming an angle that is greater than or less than 90 degrees relative to the travel path 103. In contrast with the first gas flow 419, 439 (e.g., illustrated in FIG. 4) which comprises a series of gas bursts (e.g., the first gas burst 425, 445, the second gas burst 427, 447, the third gas burst 429, 449, etc.), the second gas flow 517 can comprise a continuous gas flow that may be uninterrupted. For example, a purpose of the second gas flow 517 may be to remove the dislodged particles 467 from the second major surface 203 of the glass ribbon 107, and not to cause a vibration of the glass ribbon 107. As such, since the second gas flow 517 may not be intended to cause vibration, the second gas flow 517 can comprise the continuous gas flow that may remove the dislodged particles 467 and, in some embodiments, may dislodge some particles 465 that were not dislodged by the first gas flow 419, 439. In some embodiments, the second gas flow 517 can remove the particles 465, 467 by creating air turbulence adjacent to the second major surface 203. This air turbulence can cause the particles 465, 467 to further separate from the second major surface 203, for example, by increasing a distance that separates the particles 465, 467 from the second major surface 203.

In some embodiments, to facilitate the removal of the particles 465, 467 from a larger area of the glass ribbon 107, the second gas flow 517 can comprise a cone shape. For example, the second nozzle 503 can discharge the second gas flow 517 within a spray angle 519 range from about 0 degrees to about 180 degrees, or within a spray angle 519 range from about 0 degrees to about 90 degrees, or within a spray angle 519 range from about 20 degrees to about 90 degrees. The spray angle 519 can be varied in several ways. For example, a cross-sectional size (e.g., diameter) of the second orifice 515 can be altered, which can correspondingly alter the spray angle 519. In some embodiments, the second nozzle 503 may be fixed relative to the second wall enclosure 207, such that a location at which the second gas path 518 intersects the glass ribbon 107 may be fixed. In some embodiments, the second nozzle 503 may be movable relative to the second wall enclosure 207, for example, with the second nozzle 503 being rotatable and configured to discharge the continuous gas flow along a plurality of gas paths. For example, the second nozzle 503 may be rotatable about a rotation direction 521 relative to the first wall enclosure 205. Though the rotation direction 521 is illustrated as an up/down direction in FIG. 5, the rotation direction 521 is not so limited, and in some embodiments, the rotation direction 521 can comprise a 360 degree rotation direction 521 (e.g., up/down, into/out of the page, and at other angles in between). The rotatability of the second nozzle 503 can allow for the continuous gas flow to be discharged along a plurality of gas paths, wherein some of the gas paths may be non-perpendicular relative to the travel path 103.

In some embodiments, following the vibration of the glass ribbon 107 (e.g., by the impingement of the first gas flow 419, 439 illustrated in FIG. 4), some of the particles 465 that had accumulated on the first major surface 201 and/or the second major surface 203 may be dislodged. In some embodiments, some of the dislodged particles 467 may be loosened from the first major surface 201 and/or the second major surface 203 while still remaining in contact with the first major surface 201 and/or the second major surface 203, while other dislodged particles 467 may be completely separated and spaced apart from the first major surface 201 and/or the second major surface 203. To further assist in removing the particles 465, 467 from the glass ribbon 107, the second nozzles 501, 503 may be located downstream from the first nozzles 401, 405 (e.g., illustrated in FIG. 4). The second nozzle 501, 503 can discharge the second gas flow 507, 517 as a continuous gas flow toward the glass ribbon 107 (e.g., substantially perpendicular to or at a tilted angle (e.g., greater than or less than 90 degrees) relative to a major surface of the glass ribbon 107 of the glass ribbon 107 that is conveyed along the travel path 103). The second gas flow 507, 517 can increase the air turbulence adjacent to the first major surface 201 and the second major surface 203, with the increased air turbulence causing a separation of at least some of the particles 465, 467 from the first major surface 201 and the second major surface 203.

In some embodiments, methods of manufacturing a glass ribbon can comprise directing the second gas flow 507, 517 toward the glass ribbon 107 to remove at least a portion of the group of particles 465 from the glass ribbon 107. For example, the second nozzle 501, 503 can discharge the second gas flow 507, 517 toward the glass ribbon 107. In some embodiments, the second gas flow 507, 517 can comprise a cone shape to cover a larger area of the glass ribbon 107. The second gas flow 507, 517 can generate air turbulence adjacent to the first major surface 201 and/or the second major surface 203. The air turbulence can separate at least some of the particles 465 from the first major surface 201 and/or the second major surface 203 and/or move at least some of the dislodged particles 467 away from the first major surface 201 and/or the second major surface 203. In some embodiments, directing the second gas flow 507, 517 can comprise changing an angle of the second gas flow 507, 517 relative to the travel path 103. For example, in some embodiments, the second nozzle 501, 503 can be rotated in the rotation direction 511, 521, which can change the angle of the second gas path 508, 518 relative to the glass ribbon 107. Changing the angle may be beneficial, in part, by allowing the second gas flow 507, 517 to impact a wider area of the first major surface 201 and the second major surface 203.

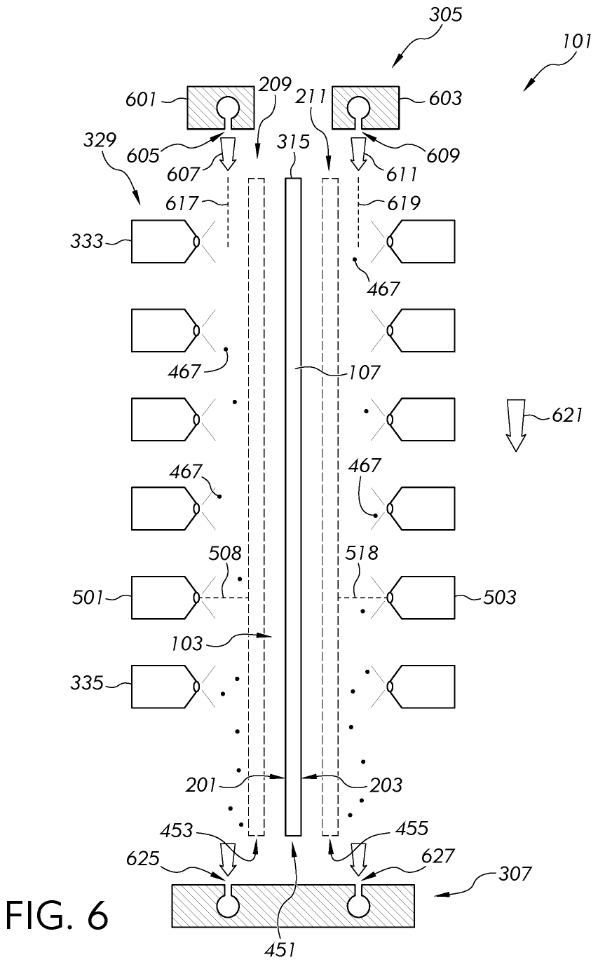

Referring to FIG. 6, a sectional view of the air cleaning device 305 and the suction device 307 along line 6-6 of FIG. 3 is illustrated. In some embodiments, the air cleaning device 305 and the suction device 307 can be positioned adjacent to opposing edges of the glass ribbon 107, for example, with the air cleaning device 305 extending adjacent to the first edge 315 and the suction device 307 adjacent to the third edge 319. The air cleaning device 305 can comprise one or more nozzles that can discharge a gas flow, for example, a third nozzle 601 and a fourth nozzle 603. The third nozzle 601 can be positioned on the first side 209 of the travel path 103, for example, with the glass ribbon 107 defining a plane and the third nozzle 601 positioned on the first side 209 of the plane. The fourth nozzle 603 can be positioned on the second side 211 of the travel path 103, for example, with the glass ribbon 107 defining a plane and the fourth nozzle 603 positioned on the second side 211 of the plane. In some embodiments, the air cleaning device 305 may not be limited to comprising the third nozzle 601 on the first side 209 and the fourth nozzle 603 on the second side 211. For example, in some embodiments, the air cleaning device 305 can comprise a plurality of third nozzles positioned on the first side 209 and spaced apart along the travel direction 105 (e.g., illustrated in FIG. 3). In some embodiments, the air cleaning device 305 can comprise a plurality of fourth nozzles positioned on the second side 211 and spaced apart along the travel direction 105.

In some embodiments, the third nozzle 601 and the fourth nozzle 603 can be substantially hollow and may comprise a third orifice 605 and a fourth orifice 609. For example, the third nozzle 601 can comprise the third orifice 605, with the third nozzle 601 configured to discharge a third gas flow 607 through the third orifice 605 along a direction that may be substantially parallel to the travel path 103. The fourth nozzle 603 can comprise the fourth orifice 609, with the fourth nozzle 603 configured to discharge a fourth gas flow 611 through the fourth orifice 609 along a direction that may be substantially parallel to the travel path 103. In some embodiments, the third nozzle 601 can discharge the third gas flow 607 along a third gas path 617 and the fourth nozzle 603 can discharge the fourth gas flow 611 along a fourth gas path 619. The third gas path 617 may be substantially parallel to the fourth gas path 619, with the third gas path 617 and the fourth gas path 619 configured to intersect the suction device 307. In some embodiments, the third gas path 617 can be substantially perpendicular to the second gas path 508 from the second nozzle 501 while the fourth gas path 619 can be substantially perpendicular to the second gas path 518 from the second nozzle 503. The third gas path 617 may be substantially parallel to the first major surface 201 and substantially perpendicular to the travel direction 105 (e.g., illustrated in FIG. 3). The fourth gas path 619 may be substantially parallel to the second major surface 203 and substantially perpendicular to the travel direction 105.

In some embodiments, the third gas flow 607 and the fourth gas flow 611 can direct the dislodged particles 467 along a suction direction 621 toward the suction device 307. For example, the suction direction 621 may be substantially parallel to the third gas path 617 and the fourth gas path 619. In some embodiments, following the dislodging of the dislodged particles 467 from the first major surface 201 and the second major surface 203 of the glass ribbon 107, at least a portion of the dislodged particles 467 may accumulate (e.g., by hovering, floating, etc.) within an airspace that may be in proximity to the first major surface 201 and/or the second major surface 203. The third gas flow 607 and the fourth gas flow 611 can remove at least a portion of the dislodged particles 467 from the airspace surrounding the glass ribbon 107 by directing the dislodged particles 467 along the suction direction 621 (e.g., downwardly in FIG. 6). In addition, by removing at least at least a portion of the dislodged particles 467 from the airspace, the likelihood of the dislodged particles 467 contacting and re-adhering to the first major surface 201 and the second major surface 203 may be reduced. This may be due, in part, to the third gas flow 607 and the fourth gas flow 611 being directed along the third gas path 617 and the fourth gas path 619 which may be substantially parallel to the glass ribbon 107.

In some embodiments, to further assist in removing the dislodged particles 467 from the airspace adjacent to the glass ribbon 107, the suction device 307 can be positioned within the housing 102 (e.g., illustrated in FIGS. 1-2) to receive the at least a portion of the group of particles, for example, the dislodged particles 467, from the glass ribbon 107. For example, the suction device 307 can be positioned to receive the third gas flow 607 from the third nozzle 601 and the fourth gas flow 611 from the fourth nozzle 603. In some embodiments, one or more fans may be in fluid communication with the suction device 307, for example, by being positioned in line with and downstream from the suction device 307. The one or more fans can generate a negative air pressure within the suction device 307 to assist in drawing the third gas flow 607, the fourth gas flow 611, and the dislodged particles 467 into the suction device 307. In some embodiments, the suction device 307 can comprise one or more suction orifices, for example, a first suction orifice 625 and a second suction orifice 627. The first suction orifice 625 can be positioned on the first side 209 of the glass ribbon 107 and the second suction orifice 627 can be positioned on the second side 211 of the glass ribbon 107. In some embodiments, the third gas path 617 can intersect the first suction orifice 625 and the fourth gas path 619 can intersect the second suction orifice 627. The first suction orifice 625 can receive the dislodged particles 467 located on the first side 209 and the second suction orifice 627 can receive the dislodged particles 467 on the second side 211. For example, the third nozzle 601 and the fourth nozzle 603 can be positioned opposite the suction device 307, with the suction device 307 configured to receive the third gas flow 607 and the fourth gas flow 611. In some embodiments, a portion of the suction device 307 can be positioned on the first side 209 of the travel path 103 opposite the third nozzle 601, with the suction device 307 configured to receive the third gas flow 607. Another portion of the suction device 307 can be positioned on the second side 211 of the travel path 103 opposite the fourth nozzle 603, with the suction device 307 configured to receive the fourth gas flow 611. The suction device 307 can therefore reduce the amount of dislodged particles 467 adjacent to the first major surface 201 and the second major surface 203, which can reduce the likelihood of the dislodged particles 467 from re-adhering to the first major surface 201 and/or the second major surface 203.

In some embodiments, methods of manufacturing a glass ribbon can comprise directing the third gas flow 607 and the fourth gas flow 611 along the glass ribbon 107 in a direction, for example, the suction direction 621, that may be substantially parallel to the travel path 103. For example, the third gas flow 607 and the fourth gas flow 611 can travel in the suction direction 621 toward the suction device 307, wherein the suction direction 621 may be substantially parallel to the travel path 103. In some embodiments, methods of manufacturing a glass ribbon can comprise receiving a portion of a group of particles, for example, the dislodged particles 467, within the suction device 307 positioned within the third gas path 617 of the third gas flow 607 and the fourth gas path 619 of the fourth gas flow 611.

In some embodiments, the glass manufacturing apparatus 101 can provide several benefits associated with cleaning the glass ribbon 107, for example, the removal of particles from the first major surface 201 and/or the second major surface 203 of the glass ribbon 107. In some embodiments, the glass manufacturing apparatus 101 can comprise the vibration inducing device 301, the particle removal device 303, the air cleaning device 305, and the suction device 307. As the glass ribbon 107 moves in the travel direction 105, the glass ribbon 107 may first pass the vibration inducing device 301. The vibration inducing device 301 can discharge one or more gas bursts toward the travel path 103 to cause a vibration of the glass ribbon 107. The vibration of the glass ribbon 107 can dislodge one or more particles 465 from the first major surface 201 and/or the second major surface 203. In some embodiments, the glass ribbon 107 can then pass the particle removal device 303, which can discharge one or more continuous streams of air to further remove the particles 465. Before, during, and/or after the glass ribbon 107 passes the particle removal device 303, the air cleaning device 305 can direct a downward stream of air substantially parallel to the glass ribbon 107. The downward stream of air can remove the dislodged particles 467 that may be present in the air adjacent to the glass ribbon 107. In some embodiments, the suction device 307 can provide a negative pressure to draw in and receive some of the dislodged particles 467, thus reducing a concentration of the dislodged particles 467 from the air. The glass manufacturing apparatus 101 can therefore remove the particles 465 from the glass ribbon 107 while avoiding contact with the glass ribbon 107, thus reducing the risk of damage.

It should be understood that while various embodiments have been described in detail relative to certain illustrative and specific examples thereof, the present disclosure should not be considered limited to such, as numerous modifications and combinations of the disclosed features are possible without departing from the scope of the following claims.

1. A glass manufacturing apparatus comprising:
a first nozzle comprising a first orifice facing a travel path of the glass manufacturing apparatus;
a gas source in fluid communication with the first nozzle and configured to direct a gas flow to the first nozzle;
a controller coupled to one or more of the gas source or the first nozzle and configured to vary the gas flow from the gas source through the first nozzle such that the first nozzle is configured to discharge a series of gas bursts through the first orifice toward the travel path at a frequency within a range from about 10 Hz to about 45 Hz; and
a second nozzle spaced apart from the first nozzle, the second nozzle comprising a second orifice facing the travel path, the second nozzle configured to discharge a continuous gas flow through the second orifice toward the travel path.

2. The glass manufacturing apparatus of claim 1, wherein the first nozzle is configured to discharge the series of gas bursts along a first gas path that is substantially perpendicular to the travel path.

3. The glass manufacturing apparatus of claim 1, wherein the second nozzle is rotatable and configured to discharge the continuous gas flow along a plurality of gas paths.

4. The glass manufacturing apparatus of claim 1, comprising a third nozzle comprising a third orifice, the third nozzle configured to discharge a third gas flow through the third orifice along a direction that is substantially parallel to the travel path.

5. The glass manufacturing apparatus of claim 4, wherein the third nozzle is positioned on a first side of the travel path.

6. The glass manufacturing apparatus of claim 5, comprising a suction device positioned on the first side of the travel path opposite the third nozzle, the suction device configured to receive the third gas flow.

7. A glass manufacturing apparatus comprising:
a housing defining a travel path extending in a travel direction, the housing configured to receive a glass ribbon along the travel path in the travel direction;
a first nozzle attached to the housing and configured to discharge a first gas flow toward the travel path to induce vibration in the glass ribbon and dislodge one or more particles of a group of particles from the glass ribbon;
a second nozzle attached to the housing and positioned downstream from the first nozzle relative to the travel direction, the second nozzle configured to discharge a second gas flow toward the travel path to remove at least a portion of the group of particles from the glass ribbon; and
a suction device positioned within the housing to receive the at least a portion of the group of particles from the glass ribbon.

8. The glass manufacturing apparatus of claim 7, wherein the first nozzle is configured to discharge the first gas flow along a first gas path that is substantially perpendicular to the travel path.

9. The glass manufacturing apparatus of claim 7, wherein the second nozzle is rotatable and configured to discharge the second gas flow along a plurality of gas paths.

10. The glass manufacturing apparatus of claim 7, comprising a third nozzle comprising a third orifice, the third nozzle configured to discharge a third gas flow through the third orifice along a direction that is substantially parallel to the travel path.

11. The glass manufacturing apparatus of claim 10, wherein the third nozzle is positioned opposite the suction device, the suction device configured to receive the third gas flow.

12. A method of manufacturing a glass ribbon comprising:
moving a glass ribbon along a travel path in a travel direction;
directing a first gas flow toward the glass ribbon at a resonant frequency of the glass ribbon within a range from about 10 Hz to about 45 Hz to vibrate the glass ribbon and dislodge one or more particles of a group of particles from the glass ribbon; and
directing a second gas flow toward the glass ribbon to remove at least a portion of the group of particles from the glass ribbon.

13. The method of claim 12, further comprising directing a third gas flow along the glass ribbon in a direction that is substantially parallel to the travel path.

14. The method of claim 13, further comprising receiving the at least a portion of the group of particles within a suction device positioned within a path of the third gas flow.

15. The method of claim 12, wherein the directing the second gas flow comprises changing an angle of the second gas flow relative to the travel path.

16. The method of claim 12, wherein the moving the glass ribbon comprises receiving the glass ribbon within an opening defined by a housing.

17. A method of manufacturing a glass ribbon comprising:
moving a glass ribbon along a travel path in a travel direction;
directing a first gas flow toward the glass ribbon to vibrate the glass ribbon and dislodge one or more particles of a group of particles from the glass ribbon;
directing a second gas flow toward the glass ribbon to remove at least a portion of the group of particles from the glass ribbon; and
receiving the at least portion of the group of particles within a suction device.

18. The method of claim 17, further comprising directing a third gas flow along the glass ribbon in a direction that is substantially parallel to the travel path.

19. The method of claim 17, wherein the moving the glass ribbon comprises receiving the glass ribbon within an opening defined by a housing.

20. The method of claim 17, wherein the directing the second gas flow comprises changing an angle of the second gas flow relative to the travel path.
